(19) United States
(12) Patent Application Publication
(10) Pub. No.: US 2010/0246928 A1
(43) Pub. Date: Sep. 30, 2010

(54) BANKNOTE RECOGNITION APPARATUS AND BANKNOTE RECOGNITION METHOD

(76) Inventors: Tomohisa Takahama, Tokyo-To (JP); Yasushi Ikeda, Kanagawa-Ken (JP)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/734,969

(22) PCT Filed: Dec. 7, 2007
(86) PCT No.: PCT/JP2007/073706

§ 371 Date: Jun. 7, 2010

(51) Int. Cl. G06K 9/00

(52) U.S. Cl. 382/140; 382/137

(57) ABSTRACT

A banknote recognition apparatus (220) for recognizing a type of a banknote includes: a detection unit configured to detect the banknote to be recognized; an evaluation-value calculation unit (30) configured to calculate each evaluation value of the banknote, by using one evaluation-value-calculation-formula set composed of a combination of a plurality of predetermined evaluation-value calculation formulae, based on a detection result obtained by the detection unit; and a recognition unit (32) for recognizing the type of the banknote, by using a plurality of predetermined threshold values respectively corresponding to each type of banknote, based on each evaluation value of the banknote calculated by the evaluation-value calculation unit (30).

### FIELD OF THE INVENTION

The present invention relates to a banknote recognition apparatus and a banknote recognition method, respectively provided for recognizing a type, such as the denomination, authenticity, fitness, new or old printed version or the like, of a banknote.

### BACKGROUND ART

In recent years, various kinds of banknote handling machines, each including the banknote recognition apparatus adapted for recognizing each type, such as a denomination, authenticity, fitness, new or old printed version and the like, of a banknote, are known.

For instance, JP3653556B discloses the banknote recognition apparatus that can accurately recognize whether or not each banknote to be recognized is a counterfeit one. In addition, JP9-245215A teaches a method for recognizing the authenticity of each banknote, by first determining the transport direction of each banknote to be recognized, and then comparing a waveform pattern of the banknote detected by a sensor, with only the waveform pattern of a reference banknote corresponding to the same transport direction. In this way, this banknote recognition method, based on the transport (or insertion) direction of each banknote, can substantially reduce the time required for recognizing the authenticity of each banknote. Further, JP11-351962A discloses an optical density detector adapted for detecting a density of a print on each banknote, thereby recognizing the authenticity, denomination and the like of the banknote, based on the level of the print density. Furthermore, U.S. Pat. No. 5,790,693 reports a banknote evaluation apparatus adapted for first recognizing the denomination of each banknote, and then calculating evaluation values, such as optical transparency, magnetic data and the like, for the banknote recognized about the denomination thereof, thereby recognizing the authenticity of the banknote, by using a plurality of threshold values, respectively corresponding to only a combination of the denomination and transport direction of the banknote to be recognized, for each calculated evaluation value.

### SUMMARY OF THE INVENTION

In the conventional banknote recognition apparatus, as disclosed in the U.S. Pat. No. 2,635,994, each evaluation value, such as the optical transparency, magnetic data or the like, of each banknote, has been calculated, by using only one evaluation-value-calculation formula, irrespectively of presence of many kinds of types, such as the denomination and the like, of the banknote. Further, only one threshold value has been set for recognizing the authenticity and/or fitness of each banknote.

In such a conventional banknote recognition apparatus, each banknote to be recognized is first detected by a detection sensor, such as a line sensor or the like, and then the denomination, authenticity or the like of the banknote is recognized, based on the detection result obtained by the detection sensor. In this case, each evaluation value (e.g., the evaluation value related to the optical transparency, magnetic data or the like) of each banknote is calculated, by using the same evaluation-value-calculation formula, regardless of presence of difference in the denomination, direction or the like between the respective banknotes. Further, for each calculated evaluation value, the only one threshold value is prepared and used for recognizing the authenticity of each banknote.

Namely, in this banknote recognition apparatus, irrespectively of the presence of difference in the denomination and the like between the respective banknotes, each evaluation value of each banknote is calculated, by using the same evaluation-value-calculation formula, and the only one threshold value is used for recognizing the authenticity and the like of the banknote. Therefore, it is true that the time required for each calculation or operation for recognizing the authenticity and/or fitness of each banknote can be considerably reduced. However, such a banknote recognition apparatus may tend to provide rather deteriorated accuracy of the recognition for each banknote.

On the other hand, as to a relatively new type of the banknote recognition apparatus, as disclosed in the aforementioned U.S. Pat. No. 5,790,693, the evaluation-value-calculation formula and threshold value corresponding to this formula are respectively prepared, in advance, for each detection element related to the recognition about the authenticity of each banknote, for each denomination of the banknote. In this case, for each banknote to be recognized, the detection is first performed by using a proper detection sensor, such as an optical sensor or the like, and then the denomination of the banknote is recognized, based on the detection result obtained by the detection sensor. During this recognition, pattern verification, for checking whether or not each banknote to be recognized is matched with a certain reference pattern, is performed for all of the denominations of the banknotes. Thereafter, for each banknote already recognized about the denomination thereof, each evaluation value, such as the optical transparency, magnetic data and the like, of the banknote is calculated, by using the evaluation-value-calculation formula corresponding to the denomination. Finally, for each calculated evaluation value, the authenticity of each banknote is recognized, by using the threshold value corresponding to the denomination of the banknote.

In this banknote recognition apparatus of the relatively new type, each evaluation value is calculated by using the evaluation-value-calculation formula corresponding to each denomination of the banknotes. Therefore, the accuracy of the recognition of the denomination and authenticity of each banknote can be substantially improved. However, in this banknote recognition apparatus, there is a need for performing the pattern verification for checking whether or not each banknote to be recognized is matched with the certain reference pattern, for all of the denominations of the banknotes, during the recognition about the denomination of each banknote. Further, this pattern verification requires the use of all evaluation-value-calculation formulae respectively different, corresponding to each denomination. Therefore, it takes so much time for performing the calculation or operation required for the recognition of each banknote.

The present invention was made in light of the above problems. Therefore, it is an object of this invention to provide the banknote recognition apparatus and banknote recognition method, which can significantly enhance the accuracy of the recognition about the denomination, authenticity, fitness, new or old printed version and the like of each banknote as well as can substantially reduce the time required for the calculation and/or operation for performing such recognition.

The banknote recognition apparatus of the present invention is adapted for recognizing a type of a banknote, the banknote recognition apparatus including: a detection unit configured to detect the banknote to be recognized; an evaluation-value calculation unit configured to calculate each evaluation value of the banknote, by using one evaluation-value-calculation-formula set composed of a combination of a plurality of predetermined evaluation-value calculation formulae, based on a detection result obtained by the detection unit; and a recognition unit for recognizing the type of the banknote, by using predetermined threshold values for each type of banknote, respectively corresponding to the plurality of evaluation-value calculation formulae, based on each evaluation value of the banknote calculated by the evaluation-value calculation unit.

In this banknote recognition apparatus, it is preferred that the type of the banknote includes at least one of the denomination of the banknote, authenticity of the banknote, fitness of the banknote and new or old printed version of the banknote. It is also preferred that the detection unit is configured to detect at least one of the thickness, size, optical transparency, optical reflectivity and magnetic data of the banknote, and the evaluation-value calculation unit is configured to calculate the evaluation value related to at least one of the thickness, size, optical transparency, optical reflectivity and magnetic data of the banknote.

Another aspect of the banknote recognition apparatus of the present invention is adapted for recognizing a first type and a second type of a banknote, the banknote recognition apparatus including: a detection unit configured to detect the banknote to be recognized; an evaluation-value calculation unit configured to calculate each evaluation value of the banknote, by using one evaluation-value-calculation-formula set composed of a combination of a plurality of predetermined evaluation-value calculation formulae, based on a detection result obtained by the detection unit; and a recognition unit for recognizing the first type of the banknote, by using predetermined threshold values for each first type of banknote, respectively corresponding to the plurality of evaluation-value calculation formulae, as well as configured to recognize the second type of the banknote, by using predetermined threshold values for each second type of banknote, respectively corresponding to the plurality of evaluation-value calculation formulae, based on each evaluation value of the banknote calculated by the evaluation-value calculation unit.

In this aspect of the banknote recognition apparatus, it is preferred that the first type of the banknote is the denomination of the banknote, and the second type of the banknote includes at least one of the authenticity of the banknote, fitness of the banknote and new or old printed version of the banknote. It is also preferred that the detection unit is configured to detect at least one of the thickness, size, optical transparency, optical reflectivity and magnetic data of the banknote, and the evaluation-value calculation unit is configured to calculate the evaluation value related to at least one of the thickness, size, optical transparency, optical reflectivity and magnetic data of the banknote.

It is also preferred that the recognition unit performs recognizing the first type of the banknote and recognizing the second type of the banknote in parallel.

The banknote recognition method of the present invention is provided for recognizing a type of a banknote, the method including: preparing one evaluation-value-calculation-formula set composed of a combination of a plurality of evaluation-value-calculation formulae, as well as preparing threshold values for each type of banknote, respectively corresponding to the plurality of evaluation-value-calculation formulae; detecting the banknote to be recognized; calculating each evaluation value of the banknote, by using the prepared one evaluation-value-calculation-formula set, based on a detection result of the banknote; and recognizing the type of the banknote, by using the threshold values prepared for each type of banknote, respectively corresponding to the plurality of evaluation-value-calculation formulae, based on each evaluation value of the banknote.

In this banknote recognition method, it is preferred that the type of the banknote includes at least one of the denomination of the banknote, authenticity of the banknote, fitness of the banknote and new or old printed version of the banknote. It is also preferred that at least one of the thickness, size, optical transparency, optical reflectivity and magnetic data of the banknote is detected during the detection of the banknote to be recognized, and the evaluation value related to at least one of the thickness, size, optical transparency, optical reflectivity and magnetic data of the banknote is calculated during the calculation of the evaluation value of the banknote.

Another aspect of the banknote recognition method of the present invention is provided for recognizing a first type and a second type of a banknote, the method including: preparing one evaluation-value-calculation-formula set composed of a combination of a plurality of evaluation-value-calculation formulae, as well as preparing threshold values for each first type of banknote, respectively corresponding to the plurality of evaluation-value calculation formulae, and threshold values for each second type of banknote, respectively corresponding to the plurality of evaluation-value calculation formulae; detecting the banknote to be recognized; calculating each evaluation value of the banknote, by using the prepared one evaluation-value-calculation-formula set, based on a detection result of the banknote; recognizing the first type of the banknote, by using the threshold values prepared for each first type of banknote, respectively corresponding to the plurality of evaluation-value-calculation formulae, based on each evaluation value of the banknote; and recognizing the second type of the banknote, by using the threshold values prepared for each second type of banknote, respectively corresponding to the plurality of evaluation-value-calculation formulae, based on each evaluation value of the banknote.

In this aspect of the banknote recognition method, it is preferred that the first type of the banknote is the denomination of the banknote, and the second type of the banknote includes at least one of the authenticity of the banknote, fitness of the banknote and new or old printed version of the banknote. It is also preferred that at least one of the thickness, size, optical transparency, optical reflectivity and magnetic data of the banknote is detected during the detection of the banknote to be recognized, and the evaluation value related to at least one of the thickness, size, optical transparency, optical reflectivity and magnetic data of the banknote is calculated during the calculation of the evaluation value of the banknote.

It is also preferred that recognizing the first type of the banknote and recognizing the second type of the banknote are performed in parallel.

According to the banknote recognition apparatus and banknote recognition method as described above, the only one evaluation-value-calculation-formula set is used for each denomination of the banknote, commonly, for calculating each evaluation value of each banknote, as compared with the prior art configured for calculating each evaluation value of each banknote, by using all of the evaluation-value-calculation formulae, corresponding to each of the denomination or the like, of the banknote. Therefore, in the case of using the banknote recognition apparatus and banknote recognition method of this invention, it is necessary to perform the calculation or operation, only once, for recognizing each type, such as the denomination, authenticity or the like, of each banknote. This can significantly reduce the time required for the calculation. In addition, the plurality of threshold values respectively set for the calculation formulae of the one evaluation-value-calculation-formula set, corresponding to the respective types, such as the denomination and the like, of each banknote, are used for recognizing such types of the banknote. Therefore, as compared with the case of using only one threshold value, regardless of the presence of difference in the denomination or the like between the respective banknotes, the banknote recognition apparatus and banknote recognition method of this invention can enhance, securely and significantly, the accuracy in the recognition for each type, such as the denomination, authenticity or the like, of each banknote.

### BRIEF DESCRIPTION OF THE DRAWINGS

FIG. 1 is a perspective view showing an external appearance of a banknote handling machine related to one embodiment of the present invention.

FIG. 2 is a diagram schematically showing internal construction of the banknote handling machine shown in FIG. 1.

FIG. 3(a) is a schematic side view showing detailed construction of a banknote recognition apparatus provided in the banknote handling machine shown in FIG. 2, and FIG. 3(b) is a schematic top view of the banknote recognition apparatus shown in FIG. 3(a).

FIG. 4 is a block diagram showing each component of the banknote recognition apparatus shown in FIG. 3.

FIG. 5 is a timing chart related to the banknote recognition apparatus shown in FIG. 3, the timing chart illustrating, in a time series, for each sensor, a period of time during which each banknote is first detected by each sensor, and then an evaluation value is calculated based on each detection result of the banknote, and finally the banknote is recognized based on the calculated evaluation value.

FIG. 6 is a diagram showing each block produced in the detection performed for each banknote by a red-light line sensor.

FIG. 7 is a diagram illustrating a threshold-value table related to the recognition performed by the red-light line sensor about the denomination of each banknote.

FIG. 8 is a diagram illustrating another threshold-value table related to the recognition performed by an infrared-light line sensor about the authenticity of each banknote.

FIG. 9 is a diagram illustrating still another threshold-value table related to the recognition performed by a magnetic sensor about the authenticity of each banknote.

FIG. 10 is a diagram illustrating still another threshold-value table related to the recognition performed by an optical sensor about the authenticity of each banknote.

FIG. 11 is a diagram illustrating still another threshold-value table, in one variation of this invention, related to the recognition performed by the infrared-light line sensor about the fitness of each banknote.

FIG. 12 is a diagram illustrating still another threshold-value table related to the recognition performed by a thickness detection sensor about the fitness of each banknote.

### DETAILED DESCRIPTION OF THE INVENTION

Hereinafter, one embodiment of the present invention will be described with reference to the drawings. As will be described below, this embodiment relates to the banknote handling machine provided with the banknote recognition apparatus related to this invention. It should be noted that this embodiment is described herein by way of example only, and is not intended in any way to limit the scope of this invention.

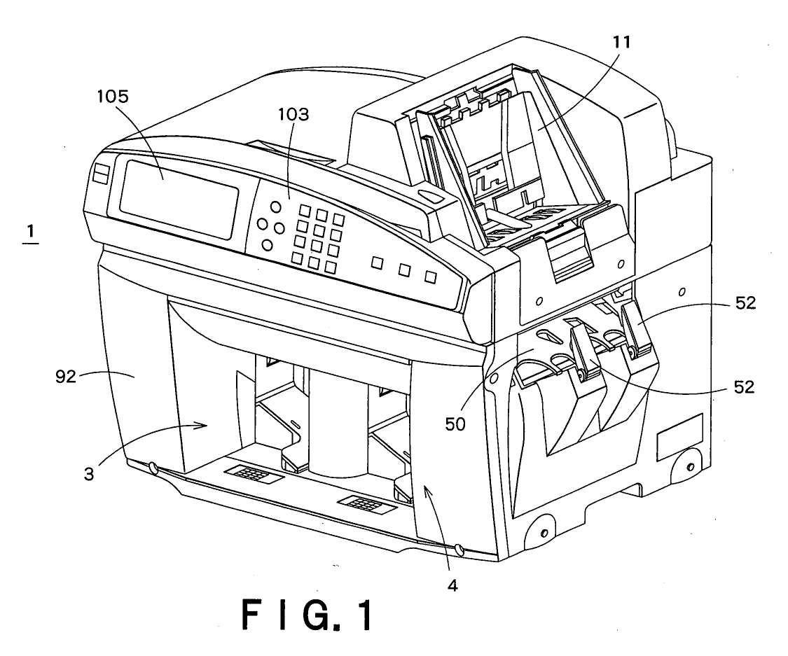

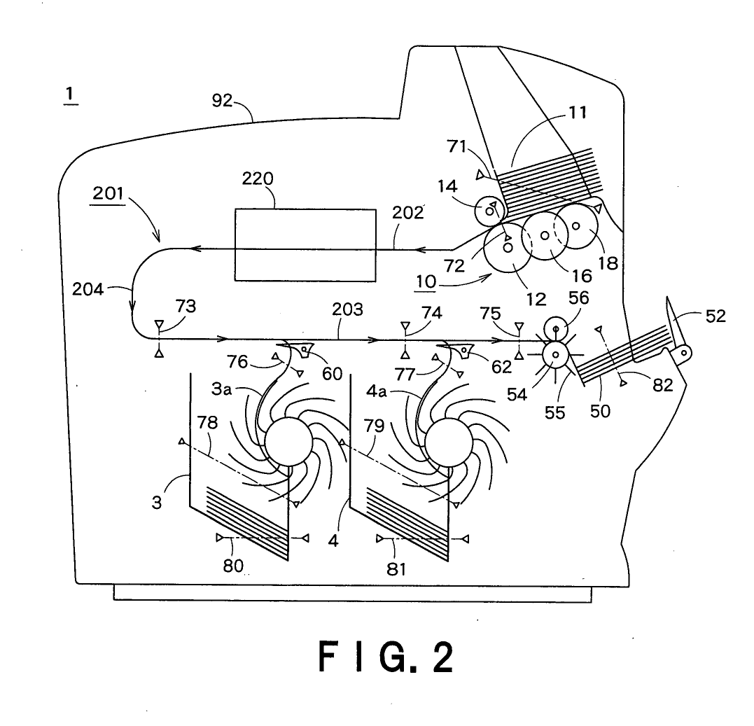

First, referring to FIGS. 1 and 2, general construction of the banknote handling machine provided with the banknote recognition apparatus related to this invention will be discussed.

FIG. 1 is a perspective view showing the external appearance of the banknote handling machine 1 related to this embodiment. As shown in FIG. 1, the banknote handling machine 1 comprises a casing 92 of a substantially rectangular parallelepiped shape, a hopper 11, a first stacking unit (or first stacker) 3, a second stacking unit (or second stacker) 4 and a reject unit 50.

FIG. 2 is a diagram which schematically shows the internal construction of the banknote handling machine 1 shown in FIG. 1, and illustrates, in particular, a transport system and a sensor system of the banknote handling machine 1. As shown in FIG. 2, a transport unit 201 is provided in the casing 92 of the banknote handling machine 1. This transport unit 201 is configured to transport the banknotes in the casing 92, successively, one by one.

Now, each component of the banknote handling machine 1 having the construction as described above will be discussed in detail.

The hopper 11 is configured such that the plurality of banknotes can be placed thereon in a stacked condition by an operator. The banknotes stored in the hopper 11 are fed into the casing 92 of the banknote handling machine 1, one by one, by a banknote feeding apparatus 10.

The banknote feeding apparatus 10 is composed of a feed roller 12 adapted for feeding each banknote, a gate roller (or reverse rotation roller) 14 provided to be opposed to the feed roller 12 and configured to form a gate part between the gate roller 14 and the feed roller 12, and kicker rollers 16, 18 respectively adapted for kicking each banknote stored in the hopper 11 toward the feed roller 12. Although the two kicker rollers 16, 18 are shown in the drawing, by way of example, while being arranged in the lateral direction, the number and arrangement manner of such kicker rollers are not limited to this aspect. For instance, only one kicker roller (e.g., the kicker roller 16) may be provided in the banknote handling machine. Then, the banknotes taken in the casing 92 by the banknote feeding apparatus 10 will be transported by the transport unit 201.

The transport unit 201 includes an upper transport mechanism 202 extending in a substantially horizontal direction, a lower transport mechanism 203 extending in the substantially horizontal direction below the upper transport mechanism 202, and an intermediate transport mechanism 204 provided between the upper transport mechanism 202 and the lower transport mechanism 203. As shown in FIG. 2, the transport unit 201 composed of the respective transport mechanisms 202, 203, 204 has a substantially U-like shape. With this configuration, the banknotes respectively taken in the casing 92 by the banknote feeding apparatus 10 are transported, successively, one by one, through the upper transport mechanism 202, intermediate transport mechanism 204 and lower transport mechanism 203, in this order. Each of the upper transport mechanism 202, intermediate transport mechanism 204 and lower transport mechanism 203 is composed of a combination of belt transport mechanisms. In this case, each belt transport mechanism is composed of a pair of or three or more rollers and a belt (e.g., a rubber belt) provided over the rollers.

As shown in FIG. 2, a banknote recognition apparatus 220 adapted for recognizing a type, such as a denomination, authenticity, fitness, new or old printed version or the like, of the banknote is provided with the upper transport mechanism 202 of the transport unit 201. The construction of the banknote recognition apparatus 220 will be detailed later.

Further, as shown in FIG. 2, two stacking units 3, 4 are juxtaposed with each other below the lower transport mechanism 203 of the transport unit 201. Each stacking unit 3, 4 is configured to store therein the banknotes respectively taken in the casing 92 and then recognized as normal ones by the banknote recognition apparatus 220, in the stacked condition, for example, for each denomination thereof. As shown in FIG. 1, the banknotes stacked in each stacking unit 3, 4 can be optionally taken out by the operator.

As shown in FIG. 2, two diverters 60, 62 are arranged, in series, along the lower transport mechanism 203. Each diverter 60, 62 has, for example, a nail-like shape, and serves to divert a part of the banknotes transported along the lower transport mechanism 203, from this lower transport mechanism 203 toward each diversion line 3a, 4a. The diversion lines 3a, 4a are connected with the first and second stacking units 3, 4, respectively. Thus, the banknotes diverted from the lower transport mechanism 203 by the diverters 60, 62 can be fed into the first and second stacking units 3, 4, via the diversion lines 3a, 4a, respectively.

At a downstream end of the lower transport mechanism 203, a release roller 54 adapted for stacking each banknote in the reject unit 50 and an opposite roller 56 arranged to be opposed to the release roller 54 are provided. With this configuration, each banknote fed to the downstream end of the lower transport mechanism 203 can be released from a gap between the release roller 54 and the opposite roller 56. Thereafter, each banknote released by the two rollers 54, 56 can be stacked, one on another, in the reject unit 50, by means of a rotary rubber vane wheel 55 which is provided around the release roller 54 and adapted for beating the banknote. This configuration can facilitate the stacking operation for the rejected banknotes in the reject unit 50, because a rear edge of each banknote released from the gap between the release roller 54 and the opposite roller 56 is beaten by the rotary rubber vane wheel 55.

Further, as shown in FIGS. 1 and 2, a stopper 52 is provided to the reject unit 50. This stopper 52 can serve to prevent each banknote, which has been released from the gap between the release roller 54 and the opposite roller 56, from coming out from the reject unit 50 to the outside of the casing 92. This stopper 52 can be rotated, by hand, in a clockwise direction in FIG. 2. Therefore, by rotating the stopper 52, by hand, in the clockwise direction in FIG. 2, the operator can optionally take out the banknotes stored in the reject unit 50.

Further, as shown in FIG. 1, an operation unit 103 and a display unit 105 are provided to the casing 92 of the banknote handling machine 1, respectively. The operation unit 103 includes input keys, each adapted for receiving instructions inputted by the operator. The display unit 105 is composed of, for example, an LCD display, and serves to display information of the banknotes stacked in each stacking unit 3, 4. More specifically, the display unit 105 can serve to display the information about at least one of the denomination, authenticity, fitness (i.e., fit or unfit banknote) and new or old printed version of each banknote to be stored in each stacking unit 3, 4, as well as the number of the banknotes stored in each stacking unit 3, 4 and total amount of money of the banknotes already stored in the stacking units 3, 4.

Next, the sensor system of the banknote handling machine 1 will be described. As shown in FIG. 2, a sensor 71 for detecting whether or not the banknotes are stacked in the hopper 11 is provided to the banknote feeding apparatus 10. Further, another sensor 72 is provided to an inlet of the upper transport mechanism 202 of the transport unit 201. This sensor 72 can serve to detect that the respective banknotes are securely taken in the casing 92.

In addition, sensors 73, 74, 75 are arranged, in this order, along the lower transport mechanism 203 of the transport unit 201, respectively, while the diverters 60, 62 are located between the sensors 73, 74 and between the sensors 74, 75, respectively. The sensor 73 is located on the upstream side relative to the diverter 60 and serves to detect all of the banknotes transported by the lower transport mechanism 203. Meanwhile, the sensor 74 is located on the downstream side relative to the diverter 60 and serves to detect only the banknotes that are not diverted toward the first stacking unit 3 by the diverter 60, among the banknotes transported by the lower transport mechanism 203. The sensor 75 is located on the downstream side relative to the diverter 62, and serves to detect only the banknotes that are not diverted toward the second stacking unit 4 by the diverter 62, among the banknotes transported by the lower transport mechanism 203.

Furthermore, sensors 76, 77 are provided to the diversion lines 3a, 4a, respectively. These sensors 76, 77 can serve to detect the banknotes respectively diverted from the lower transport mechanism 203 and fed to the diversion lines 3a, 4a, respectively.

Additionally, sensors 78, 79 are provided to middle parts of the first and second stacking units 3, 4, respectively. These sensors 78, 79 can serve to detect that the banknotes are stacked in each stacking unit 3, 4, in an abnormal state, such as a standing state or the like, respectively. Furthermore, sensors 80, 81 are provided to lower parts of the first and second stacking units 3, 4, respectively. These sensors 80, 81 can serve to detect whether or not the banknotes are stored in the stacking units 3, 4, respectively. In addition, a sensor 82 is provided to the reject unit 50. This sensor 82 can serve to detect whether or not the banknotes are stored in the reject unit 50.

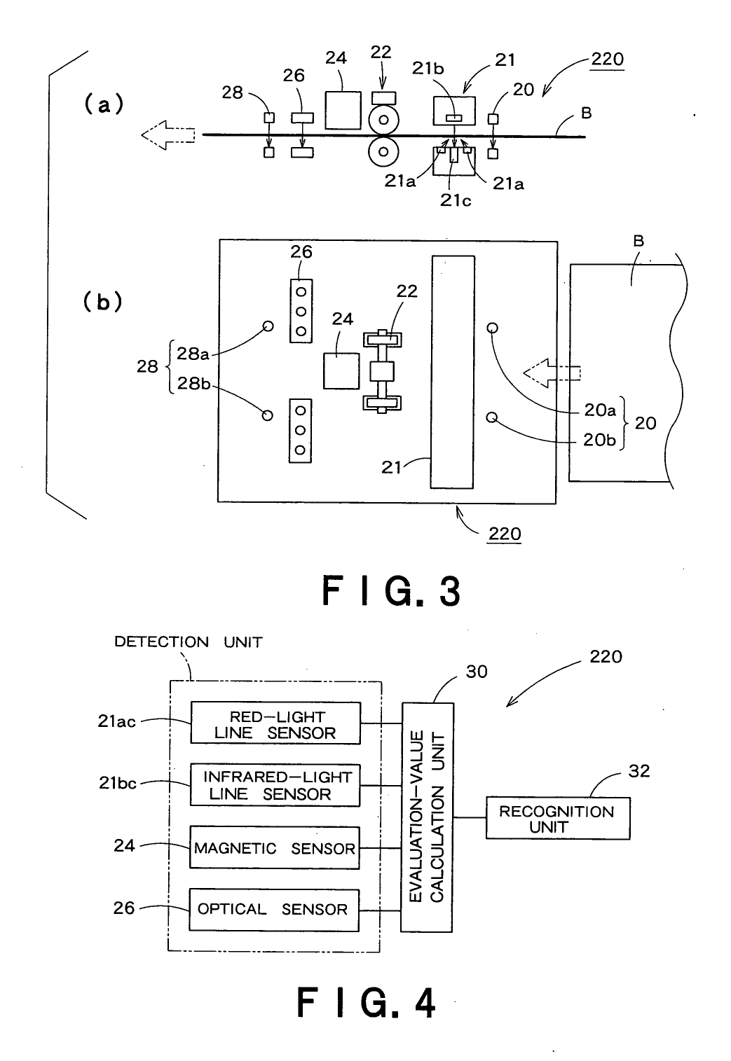

Now, referring to FIGS. 3 and 4, the construction of the banknote recognition apparatus 220 will be detailed. FIG. 3 shows details of the construction of the banknote recognition apparatus 220 provided in the banknote handling machine 1 shown in FIG. 2, and FIG. 4 is a block diagram for illustrating each component of the banknote recognition apparatus 220 shown in FIG. 3. In FIGS. 3(a), 3(b), each banknote is designated by reference character B.

FIG. 3(a) is a side view schematically showing the construction of the banknote recognition apparatus 220, and FIG. 3(b) is a top view of the banknote recognition apparatus 220. As shown in these drawings, the banknote recognition apparatus 220 includes a line sensor 21, a thickness detection sensor 22, a magnetic sensor 24 and an optical sensor 26, respectively arranged in this order from the upstream side. The line sensor 21, as shown in the drawings, is provided as a combination of a reflection-type red-light line sensor 21ac and a transparent-type infrared-light line sensor 21bc, wherein an image sensor 21c is commonly used for the respective sensors 21ac, 21bc. Specifically, the reflection-type red-light line sensor 21ac uses the image sensor 21c for receiving visible red light emitted from a visible-red-light source 21a and then reflected by each banknote, while the transparent-type infrared-light line sensor 21bc uses the image sensor 21c for receiving infrared light emitted from an infrared-light source 21b and then transmitted through the banknote. In this case, the red light and infrared light are emitted from the respective light sources, in a time sharing manner, respectively. Further, as shown in the drawings, timing sensors 20, 28, for respectively detecting the time of arrival of each banknote, are provided in left and right positions of the transport path in the banknote recognition apparatus 220. In place of the visible red light emitted from the light source 21a, blue light, green light and the like can also be selected, depending on the color of ink printed on each banknote.

As shown in FIG. 4, each sensor 21ac, 21bc, 24 and 26 is connected with an evaluation-value calculation unit 30, so that each detection result obtained by detection due to each sensor 21ac, 21bc, 24 and 26 can be transmitted to the evaluation-value calculation unit 30. This evaluation-value calculation unit 30 is configured to calculate each evaluation value of the banknote, by using one evaluation-value-calculation-formula set, i.e., the combination of the plurality of predetermined evaluation-value calculation formulae, based on the detection result of each sensor 21ac, 21bc, 24 and 26. More specifically, when one banknote is detected by, for example, the red-light line sensor 21ac, the detection result will be transmitted to the evaluation-value calculation unit 30. Then, from the detection result about this banknote, one evaluation value related to the red-light line sensor 21ac is calculated by using a predetermined certain first evaluation-value calculation formula. Further, from the detection result about the banknote that is obtained by the infrared-light line sensor 21bc, another evaluation value related to the infrared-light line sensor 21bc is calculated by using a predetermined certain second evaluation-value calculation formula. Similarly, based on the detection results about the same banknote respectively obtained by the detection by the magnetic sensor 24 and optical sensor 26, other evaluation values respectively related to the magnetic sensor 24 and optical sensor 26 are calculated, by using predetermined certain third and fourth evaluation-value calculation formulae. In this way, the respective evaluation values are calculated in the evaluation-value calculation unit 30, based on the detection results obtained by the detection due to the respective sensors 21ac, 21bc, 24 and 26. Namely, in this case, the aforementioned one evaluation-value-calculation-formula set is provided as a combination of the first to fourth evaluation-value calculation formulae.

As shown in FIG. 4, a recognition unit 32 is connected with the evaluation-value calculation unit 30. Thus, the four kinds of evaluation values respectively calculated by the evaluation-value calculation unit 30 can be transmitted to the recognition unit 32. This recognition unit 32 can serve to recognize the type, such as the denomination, authenticity and like, of each banknote, based on the four kinds of evaluation values respectively calculated by the evaluation-value calculation unit 30. It is noted that the method for recognizing the type, such as the denomination, authenticity and the like, of each banknote will be discussed later.

Now, the construction of the banknote recognition apparatus 220 will be described, as well as the method for calculating the evaluation value will be detailed.

As the timing sensor 20 located on the most upstream side in the banknote recognition apparatus 220, timing sensors 20a, 20b are provided, respectively, at right and left points along the transport direction of each banknote. These timing sensors 20a, 20b can respectively serve to detect the arrival of each banknote at the banknote recognition apparatus 220. Meanwhile, as the timing sensor 28 located on the most downstream side in the banknote recognition apparatus 220, two timing sensors 28a, 28b are provided, respectively, at right and left points along the transport direction of each banknote. These timing sensors 28a, 28b can respectively serve to detect each banknote that is about to be fed out from the banknote recognition apparatus 220. In the line sensor 21, as shown in FIG. 3, two red-light LED arrays 21a are provided, respectively, on the front and back sides of the image sensor 21c adapted for receiving the light, below and along the transport path for the banknotes. These red-light arrays 21a are respectively arranged to radiate the red light toward each banknote transported by the transport unit 201. Meanwhile, one infrared-light LED array 21b adapted for emitting the infrared light is provided above the transport path for the banknotes, while being opposed to the image sensor 21c. More specifically, the image sensor 21c includes light receiving elements arranged therein with a 0.25 mm pitch. With this configuration, the detection result of the image sensor 21c can be read out, with a 1.5 mm pitch of the transportation of each banknote, by using a mechanical clock (not shown) capable of generating a pulse in synchronism with the transportation of the banknote. In this case, the operations for emitting the light from the two kinds of light sources and those for reading the light emitted from the respective light sources, are respectively performed in the time sharing manner. In the case each banknote to be recognized is the dollar banknote having a 156 mm width and a 66 mm length, the reading operation is theoretically performed for 624 pixels (or picture elements) in the long-edge direction of the banknote as well as performed for 44 lines in the short-edge direction thereof, thereby reading 27,456 pixel data for each light source. Actually, however, in view of some positional shift of each banknote in the width direction of the transport path for the banknote, some delay in the transportation and the like, the reading operation should be performed over a wider range than that for obtaining the above 27,456 pixel data.

Namely, each banknote may tend to be transported in a rather skewed state, during the transportation thereof over the line sensor 21. Further, because the width of the transport path is designed to be greater than the width (length of the long-edge) of each banknote, the banknote is likely to be shifted in position, individually, in the lateral direction. Thus, it is necessary to first obtain the skewed angle and central coordinates of each banknote, based on the detected outer shape thereof, and then correct such skew and positional shift of the banknote, so as to be an image having no skew and certain positional shift. JP2001-101473A discloses one approach for this correction. It should be noted that this patent document JP2001-101473A, and all other patent documents and references identified herein, are hereby incorporated herein by reference. More specifically, the image of each banknote produced by the red-light source is first read out by the red-light line sensor 21ac, then the central coordinates are calculated and the skew angle is determined, respectively, based on the information about the outer periphery or shape of the so-obtained banknote image. Thereafter, by utilizing these results, rotation and shift operations of the red-light image data and infrared-light image data stored in a memory, are performed, thereby eliminating a need for considering such positional shift and skewed angle of each banknote that will be further processed later.

Next, the denomination of each banknote is recognized by using the red-light image data. FIG. 6 shows each block produced by collecting a predetermined number of pixels. Namely, FIG. 6(A) shows one pixel, and FIG. 6(B) illustrates one block produced by collecting four pixels. As shown in FIG. 6(B), each block is designated by Aij, wherein the character i denotes each coordinate in the horizontal direction in the drawing, while the character j denotes each coordinate in the vertical direction in the same drawing. Further, one block value of the block Aij, i.e., the total value of the four pixels, is expressed herein by Bij. In this case, each block and/or block value can be determined experimentally.

In the case the dollar banknotes are used as the banknotes to be recognized, each block is obtained to determine the denomination and transport direction of each banknote, by considering the position of a portrait, the position of an edge of the portrait, the position of a jacket of portrait, the position of each character and the like, respectively printed on the front face of the banknote, as well as by considering a part of a building, another part depicting the sky, a blank part with no ink printed thereon and the like, respectively printed or depicted in the back face of the banknote. Further, suitable calculation formulae and threshold values, respectively required for the determination of the denomination and transport direction of each banknote, are prepared in advance.

For instance, a plurality of evaluation formulae, such as “an upper-limit value 1>B11+B34> a lower-limit value 1,” are prepared. In this expression, “B11+B34” designates one evaluation-value calculation formula, while the “upper-limit value 1” and “lower-limit value 1” denote the threshold values, respectively. While an addition expression is used herein by way of example as the evaluation-value calculation formula, the evaluation formula may be expressed by any suitable combination of the addition and subtraction, or otherwise may include at least one of the addition, subtraction, multiplication and division. Alternatively, this evaluation formula may include a differential expression. Further, rather than using the addition of the two block values, the evaluation formula may be expressed by the addition of three or more block values or by any suitable combination of these block values. In reality, such block is selected to determine, more effectively and accurately, the denomination and transport direction of each banknote to be recognized. It should be noted that the plurality of evaluation formulae are used herein. This is because only one evaluation formula can only determine a difference between certain denominations, but cannot well determine the difference between other certain denominations. Namely, in some cases, there is a risk that different denominations may be evaluated, with the same evaluation value, due to the use of such only one evaluation formula. Therefore, this embodiment is intended to determine such different denominations, more accurately, by using the plurality of evaluation formulae.

In the preparation of each evaluation formula, a certain combination of the block values that can be used for determining the denomination and transport direction of each banknote to be recognized is first selected from all of the combinations of the block values, and then the upper limit value and lower limit value, respectively suitable for each denomination and each transport direction, are determined and provided to the so-selected certain combination of the block values. In this way, a certain evaluation formula, such as “the upper-limit value 1>B11+B34> the lower-limit value 1,” “the upper-limit value 2>B13+B45> the lower-limit value 2,” and the like, can be prepared.

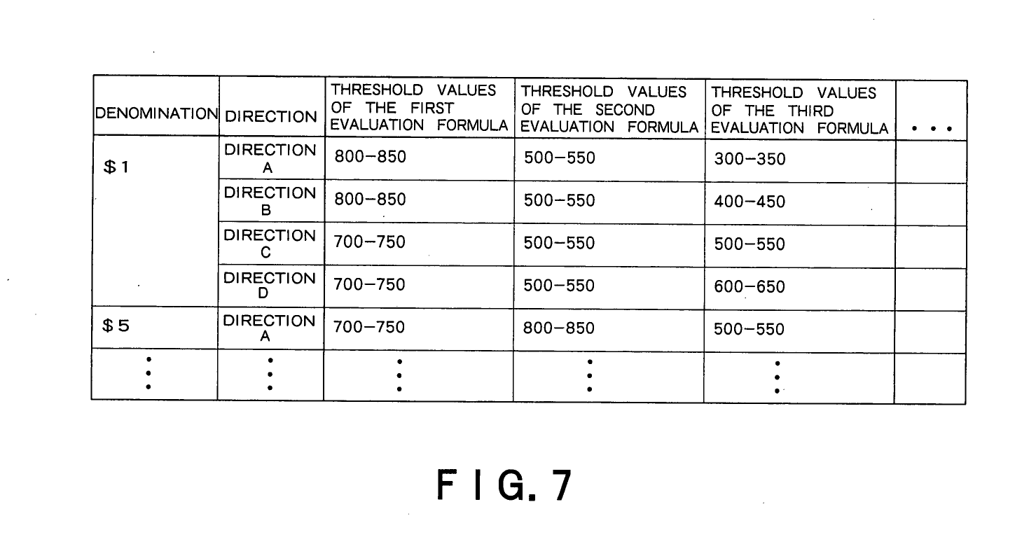

As described above, for recognizing each banknote, the plurality of evaluation formulae are usually required. The evaluation of the evaluation value obtained, such as by adding the block values, and the like, can be performed by checking whether or not this evaluation value is within a certain range of the threshold value determined between the corresponding upper limit value and the corresponding lower limit value, after calculations of the evaluation values are performed for one banknote. In this case, since the evaluation value is calculated by the block value obtained by only scanning the red-light line sensor 21ac over each banknote to be recognized, such comparison and determination process can be performed in a substantially short time. FIG. 7 shows one exemplary threshold-value table related to the recognition of the denomination of each banknote associated with the red-light line sensor 21ac about the denomination of each banknote.

Now, the determination about the authenticity of each banknote by using the infrared-light image data obtained by the infrared-light line sensor 21bc will be discussed. As is similar to the case of the red-light line sensor, the skewed angle and central coordinates of each banknote can be respectively obtained by the image data. Thus, the rotation and transfer operations of the image data are performed, respectively required for correcting such a skewed angle and positional shift relative to the reference infrared-light image data. The evaluation-value calculation formulae and evaluation values can be prepared in the same manner as those prepared for the recognition of the denomination based on the red-light image data. Generally, however, the infrared light has spectral absorption properties different from those of the visible light coming from the ink printed on each banknote. Therefore, such infrared light is suitable, in particular, to be used for the determination on the authenticity of each banknote.

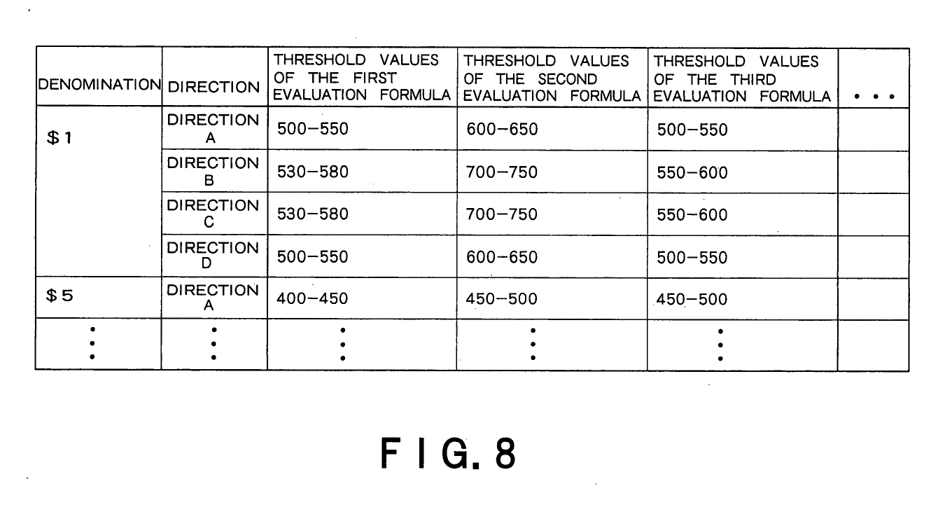

FIG. 8 illustrates one exemplary threshold-value table related to the recognition performed by the infrared-light line sensor 21bc about the authenticity of each banknote. As shown in the drawing, the upper-limit values and lower-limit values are prepared in this table, respectively, for each denomination and each transport direction of the banknotes.

Next, the magnetic sensor 24 will be described. Specifically, as is similar to the recognition about the authenticity associated with the infrared-light line sensor 21bc, a differentiated signal is outputted from a magnetic head or magneto-resistive element of the magnetic sensor 24, corresponding to the quantity of magnetism of magnetic ink printed on each banknote. Namely, in the recognition of the authenticity of each banknote associated with this magnetic sensor 24, each evaluation value is obtained, as the total sum, over one sheet of each banknote, of AD conversion value from each voltage value obtained by integrating the differentiated signal or of AD conversion value from the pre-integrated value. Also in this case, each magnetic signal is read out, with a constant interval, such as the 0.25 mm pitch, in synchronism with the mechanical clock.

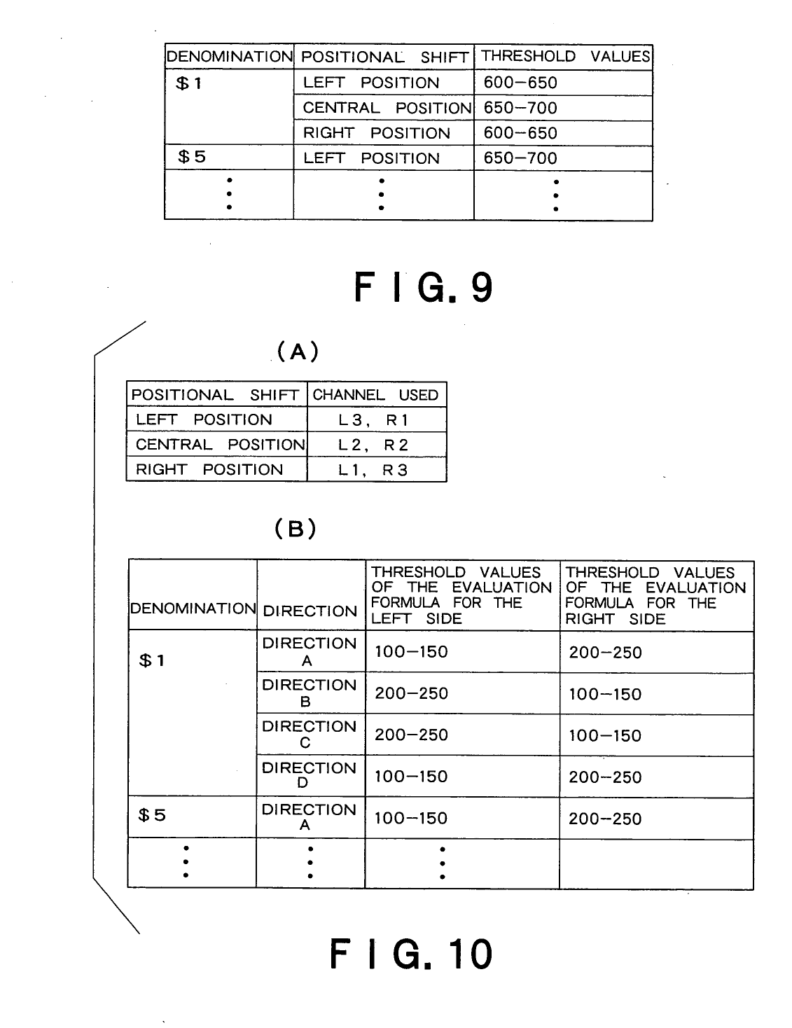

FIG. 9 shows one exemplary threshold-value table related to the recognition associated with the magnetic sensor 24 about the authenticity of each banknote. As shown in this drawing, the upper-limit values and lower-limit values are prepared in this table, respectively, for each denomination and each positional shift of the banknotes. In addition to the denomination and positional shift, the threshold-value table may be prepared, further including the transport direction and skewed angle of each banknote. However, if the magnetic head of the magnetic sensor 24 is designed to have an adequately widened detection gap or width, the skewed angle can be substantially neglected. In addition, by using the total sum of the respective AD-converted values as described above, the transport direction can also be omitted. However, in regard to the positional shift of each banknote, if the width crossing the transport path of a certain banknote to be transported through the transport unit 201 is considerably greater than the width of the dollar banknote and thus the positional shift of such a certain banknote may tend to unduly pass over the detection gap or width of the magnetic head, it is preferred to prepare the threshold-value table corresponding to the positional shift.

Now, the optical sensor 26 will be discussed. For instance, this optical sensor 26 is composed of light emission parts and light receiving parts, respectively arranged to be opposed to one another across the transport unit 201 for the banknotes. In this case, each light emission part can emit light (e.g., the visible light, infrared light, ultraviolet light or the like) of a certain wavelength, while each light receiving part can receive the light (e.g., the visible light, infrared light, ultraviolet light or the like) of the certain wavelength. However, the wavelength of the emitted light may not be necessarily the same as the wavelength of the received light. Namely, by detecting a certain part of each banknote (e.g., the whole surface of the banknote, the paper quality of the banknote, a part printed with ink, and the like) using the light emission parts and light receiving parts, the authenticity of the banknote can be determined. The optical sensor 26 has three sensors on the right side and three sensors on the left side, such that any one of the light receiving parts can always scan the certain part of each banknote, even though the banknote passes through any point of the transport path. Namely, the six sensors are positioned such that any one of such sensors can always read a certain part of each banknote, even though the banknote is transported through any point relative to the left-right direction of the transport path. In this case, the three sensors provided on the left side are respectively designated by L1, L2, L3, in this order, from the outside. Meanwhile, the three sensors provided on the right side are respectively designated by R1, R2, R3, in this order, from the outside.

As is similar to the recognition about the authenticity by the infrared-light line sensor 21bc and magnetic sensor 24, the output signal of the optical sensors 26 is obtained, as the total sum, over the one sheet of each banknote, of each value obtained by subjecting the output voltage, which corresponds to the amount of the light transmitted through the banknote and then received by each light receiving part, and AD converted, at a constant interval, such as 0.5 mm pitch. In this case, a distal end part and a rear end part of each banknote are respectively excluded from the recognition operation. Further, the position of each sensor 26 is determined in advance to read out the certain part of each banknote, corresponding to any positional shift of the banknote. Thus, the positional-shift information about each banknote given from the red-light line sensor 21ac can determine which of sensor 26 should be used for reading the certain part of the banknote. In this way, the recognition about the authenticity of each banknote can be performed, by using each threshold-value table prepared for the denomination and transport direction of each banknote. FIG. 10 shows an exemplary threshold-value table related to the recognition performed by the optical sensor 26 about the authenticity of each banknote. In this embodiment, although the positional shift of each banknote is discussed in regard to a left position, a central position and a right position of the banknote, such positions can be divided more finely, with more finely divided information read by the red-light line sensor 21ac. Therefore, many threshold values for the respective evaluation values can be prepared.

Next, the operation of the banknote handling machine 1 constructed as described above will be discussed.

First, a batch of the banknotes is stored in the hopper 11. Then, the banknotes stored in the hopper 11 are taken in the banknote handling machine 1 by the banknote feeding apparatus 10. Thereafter, the banknotes taken in the banknote handling machine 1 are transported by the transport unit 201 to the banknote recognition apparatus 220.

In the banknote recognition apparatus 220, as shown in FIG. 3, each banknote is detected successively by the red-light line sensor 21ac, infrared-light line sensor 21bc, magnetic sensor 24 and optical sensor 26.

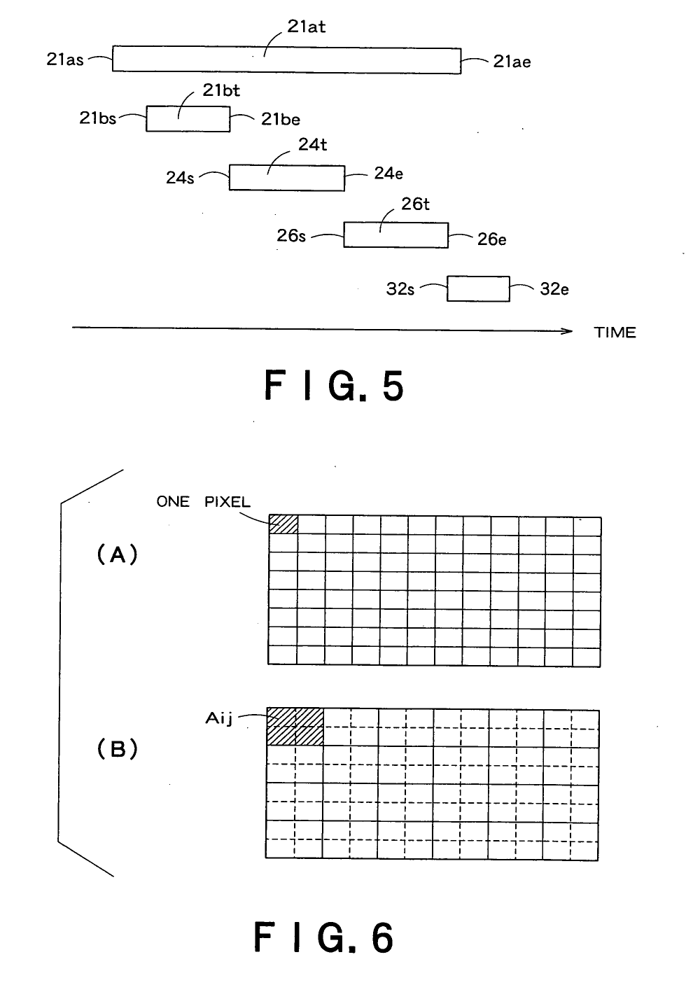

More specifically, the detection is performed based on the timing chart as shown in FIG. 5. Namely, a recognition result about the denomination and transport direction of each banknote is first outputted from the red-light line sensor 21ac. Meanwhile, from the infrared-light line sensor 21bc, information about a candidate of denomination and transport direction of a genuine banknote is outputted. In addition, further information about the candidate of the correct denomination of the banknote is outputted from the magnetic sensor 24. As it is empirically known, it is rather difficult, for a magnetic sensor 24 located to take a substantially central position of each transported banknote, to recognize finely denomination of the banknote, and a plurality of candidates on the denomination are usually obtained.

Information about the candidate of the denomination and transport direction of a genuine banknote can be obtained from the optical sensor 26. However, since this optical sensor 26 utilizes the light transmitted through each banknote, it is rather difficult to determine the face/back of the banknote. Additionally, a quite similar design printed on each banknote, for expressing the denomination thereof, often makes it necessary to obtain so many candidates.

In the overall recognition about the denomination, transport direction and authenticity of each banknote, the authenticity for the denomination determined by the red-light line sensor 21ac is recognized in accordance with the result whether or not the candidates of the denomination and transport direction of the banknote respectively recognized to be genuine by the respective sensors 21bc, 24, 26 include the denomination and transport direction determined by the red-light line sensor 21ac, when all of the recognition results are collected from the respective sensors 21ac, 21bc, 24, 26. For instance, if the red-light line sensor 21ac outputs the information that the banknote is identified as a 10 dollar banknote and transport direction A, while the candidates respectively recognized to be correct and outputted by the respective sensors 21bc, 24, 26 include the candidate corresponding to the 10 dollar and transport direction A, the overall recognition result will be outputted, showing that the banknote has been recognized as a genuine 10 dollar banknote transported in the transport direction A. Meanwhile, if the candidates outputted from the respective sensors 21bc, 24, 26 do not include such a candidate as outputted from the red-light line sensor 21ac, this banknote is recognized as a counterfeit 10 dollar banknote in the transport direction A.

In the final recognition about the denomination and authenticity of each banknote, each recognition result about the denomination and transport direction of the banknote obtained by each sensor 21ac, 21bc, 24, 26 is subjected to a logical AND operation. As a result, when each sensor 21bc, 24, 26 judges that the banknote recognized by the red-light line sensor 21ac is genuine in regard to the denomination and transport direction thereof, the final recognition result will be outputted, showing that the denomination of the banknote is genuine. Meanwhile, if a flag showing that the denomination recognized by the red-light line sensor 21ac is true is not set by any one of the sensors 21bc, 24, 26, the final recognition result showing that the banknote recognized by the red-light line sensor 21ac is the counterfeit banknote in regard to the denomination will be outputted to, for example, the display unit 105 or another host machine.

Now, referring to the timing chart of FIG. 5, the operation that each sensor 21ac, 21bc, 24, 26 detects each banknote and then the denomination and authenticity thereof is recognized, will be discussed. FIG. 5 illustrates, in the time series for each sensor 21ac, 21bc, 24, 26, the period of time during which each banknote is first detected by each sensor 21ac, 21bc, 24, 26, respectively provided in the banknote recognition apparatus 220 shown in FIG. 3, and then each evaluation value is calculated based on each detection result about the banknote, and finally the banknote is recognized based on the calculated evaluation value.

In FIG. 5, reference numeral 21at denotes a period of time during which one banknote is first detected by the red-light line sensor 21ac and finally the denomination of the banknote is recognized by the red light. In this case, reference numeral 21 as designates the time at which the detection of the banknote by the red-light line sensor 21ac is started, while reference numeral 21ae designates the time at which the recognition about the denomination of the banknote is ended. Similarly, reference numeral 21bt denotes a period of time during which one banknote is first detected by the infrared-light line sensor 21bc and finally the denomination and authenticity of this banknote are respectively recognized. In this case, reference numeral 21bs designates the time at which the detection of the banknote by the infrared-light line sensor 21bc is started, while reference numeral 21be designates the time at which the recognition about the denomination and authenticity of the banknote is ended. Reference numeral 24t denotes a period of time during which one banknote is first detected by the magnetic sensor 24 and then the denomination and authenticity of the banknote are respectively recognized. Reference numeral 26t denotes a period of time during which one banknote is first detected by the optical sensor 26 and then denomination and authenticity of this banknote are respectively recognized. In this case, reference numerals 24s, 26s respectively designate the time at which the detection of the respective banknotes due to the magnetic sensor 24 and optical sensor 26 is started, while reference numerals 24e, 26e respectively designate the time at which the recognition about the denomination and authenticity of the respective banknotes is ended. In addition, reference numeral 32s designates the time at which the recognition, about whether or not the denomination and transport direction of the banknote respectively determined by the red-light line sensor 21ac is included in the candidates of the denomination and transport direction of the banknote respectively recognized to be genuine by the respective sensors 21bc, 24, 26, is started, when all of the recognition results of the respective sensors 21ac, 21bc, 24, 26 are collected. Meanwhile, reference numeral 32e designates the time at which the recognition started at the time 32s is ended.

As shown in FIG. 5, the period of time 21at during which one banknote is first detected by the red-light line sensor 21ac and the denomination of this banknote is recognized by the same sensor 21ac is set longer than each of the periods of time 21bt, 24t, 26t, during which the banknote is first detected by the respective sensors 21bc, 24, 26 and finally the denomination and authenticity of the banknote is recognized by the same sensors 21bc, 24, 26. However, as shown in FIG. 5, the recognition operation for the first type (i.e., the denomination) of each banknote and the recognition operation for the second type (e.g., the authenticity) can be performed simultaneously. Therefore, the time required for the mathematical operation for recognizing both of the denomination and authenticity of each banknote can be substantially reduced.

As stated above, according to the banknote handling machine 1 of this embodiment, each banknote to be recognized is first detected by the respective sensors 21ac, 21bc, 24, 26, and then the respective evaluation values for the banknote are calculated by using the predetermined one evaluation-value-calculation-formula set (i.e., the combination of the first to fourth evaluation-value calculation formulae), based on the detection results obtained by the respective sensors 21ac, 21bc, 24, 26, and finally the respective types, such as the denomination, authenticity and the like, of the banknote are recognized by using the plurality of predetermined threshold-values (see the tables respectively shown in FIGS. 7 through 10) respectively corresponding to the types, such as the denomination, authenticity and the like, of the banknote, based on the respective evaluation values calculated for the banknote. Accordingly, as compared with the conventional case in which the respective evaluation values of each banknote should be calculated, each time, by using all of the evaluation-value calculation formulae respectively corresponding to each denomination and the like, of the banknote, the banknote recognition apparatus of this embodiment prepares, in advance, one evaluation-value-calculation-formula set that can commonly accommodate over the mathematical operations for calculating such a plurality of evaluation values. Therefore, in this embodiment, the calculation necessary for the recognition about the respective types, such as the denomination, authenticity and the like, of each banknote has to be performed, only once, thereby significantly reducing the time required for the recognition. Additionally, in this embodiment, the recognition about the respective types, such as the denomination, authenticity and the like, of each banknote is performed by using the plurality of threshold values respectively set, in advance, corresponding to such types. Thus, as compared with the conventional case in which only one threshold value is provided for the evaluation on such types, irrespectively of the difference in the denomination and the like between banknotes, the banknote recognition apparatus of this embodiment can securely enhance the accuracy of the recognition about the types, such as the denomination, authenticity and the like, of each banknote.

It is noted that the banknote recognition apparatus and banknote recognition method of the present invention are not limited to each aspect as described above, but may be modified or altered without departing from the scope of this invention.

Namely, the above aspect has been described about the case in which the banknote recognition apparatus 220 is used for recognizing both of the denomination and authenticity. However, the present invention is not limited to this case. For instance, the banknote recognition apparatus 220 may recognize only the denomination of each banknote, or otherwise may recognize only the authenticity of the banknote. Also in such a case, each banknote is detected by a part or all of the sensors 21ac, 21bc, 24, 26 of the banknote recognition apparatus 220, so that the evaluation values related to such a part or all of the sensors 21ac, 21bc, 24, 26 can be calculated by the evaluation-value calculation unit 30, based on each detection result. Then, at the recognition unit 32, the denomination or authenticity of the banknote will be recognized, by using the plurality of predetermined threshold values respectively corresponding to the denomination of the banknote or by using the plurality of predetermined threshold values respectively corresponding to the authenticity of the banknote. Thus, in view of a part or all of the recognition results respectively corresponding to the detection results of the sensors 21ac, 21bc, 24, 26, the final recognition will be performed about the denomination or authenticity of the banknote.

The banknote recognition apparatus 220 may also recognize the fitness or new or old printed version (e.g., the year in which the dollar banknote was issued), other than the denomination, transport direction and authenticity of each banknote. Alternatively, the banknote recognition apparatus 220 may recognize the denomination of each banknote, while recognizing the fitness or new or old printed version of the banknote.

Now, by way of example, one aspect of the banknote recognition apparatus 220, which recognizes the denomination of each banknote, while recognizing the fitness of the banknote, will be described.

In this case, the fitness of each banknote can be recognized, with provision of a proper means adapted for detecting the amount of transmitted light, corresponding to the infrared-light LED source of the infrared-light line sensor 21bc. This means can exhibit such properties that the amount of the output will be increased when the detected banknote is relatively new, while being decreased when the detected banknote becomes relatively old, because of absorption of the transmitted light due to dirt or the like present on such an old banknote. Namely, by utilizing such properties, the fitness of each banknote can be recognized, by setting classification of the transmitted light amount into several evaluation levels.

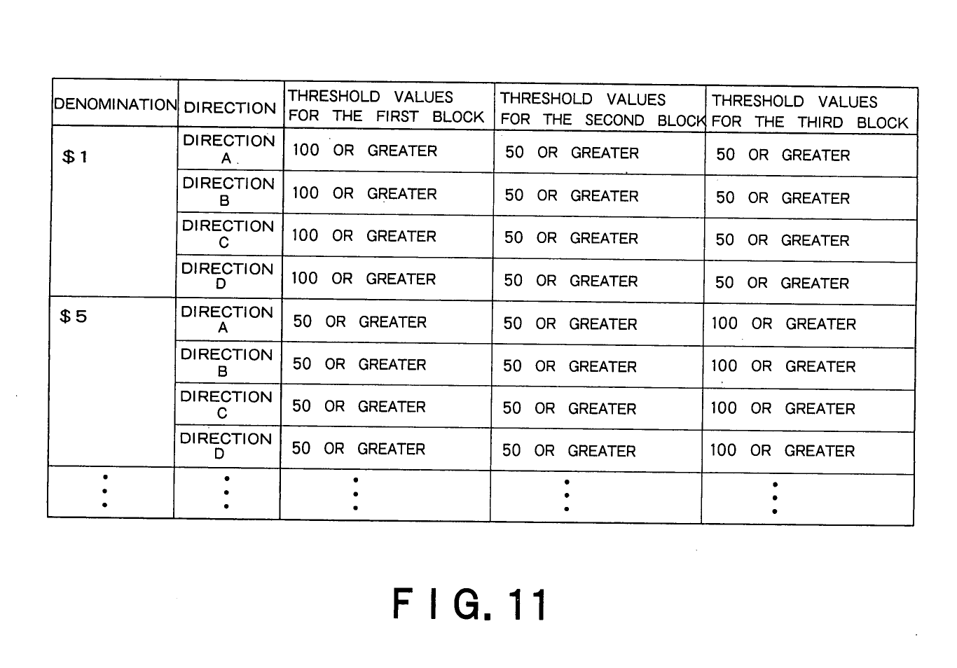

The fitness of each banknote can be recognized, based on each block value Bij (wherein i designates each channel number, while j designates each number of the order from the forefront block), as set forth in the above description about the infrared-light line sensor 21bc. For the recognition of the fitness of each banknote, the blank part with no ink printed thereon is generally utilized. Thus, for each of the four directions of each banknote, each block to be recognized is selected in a place where the blank part is present. FIG. 11 shows one exemplary threshold-value table related to the recognition about the fitness performed by the infrared-light sensor 21bc.

Now, the thickness detection sensor 22, for use in one variation, will be described. This thickness detection sensor 22 has two shafts respectively arranged in parallel with each other (wherein a first shaft is located below the transport path for the banknotes, while a second shaft is located above the transport path), with a pulley attached to each end thereof. To the first shaft, a reference roller having a usual construction is attached. To the second shaft, a detection roller is provided, while being arranged above and axially parallel with the reference roller.

A connection member composed of a support rubber is fitted between the second shaft and a cylindrical member constituting the detection roller. Namely, the cylindrical member is attached to the second shaft via the connection member. Thus, the detection roller can be pressed against the corresponding reference roller, with the outer circumferential faces of the two rollers usually brought into contact with each other.

A detection piece for detecting a transfer amount of the detection roller is provided to a top face of the detection roller. A magnetic sensor for detecting the movement of the detection piece is located above the detection piece. In this case, the detection roller is biased downward by a spring. The magnetic sensor can output some voltage in proportion to the transfer amount of the detection roller. In a period of waiting time, the detection roller is in contact with the reference roller, and the output of the magnetic sensor in this waiting time is memorized, as a reference value.

When one normal banknote is advanced between the upper and lower rollers, the detection roller is raised upward, corresponding to the thickness of the banknote. Thereafter, the magnetic sensor reads such a raised amount of the detection roller, and then outputs a signal corresponding to the transfer amount. If two overlapped banknotes are advanced together between the rollers, the detection roller will be raised, corresponding to the thickness of the two banknotes. Thus, the magnetic sensor will read this raised amount, and then output the signal corresponding to the transfer amount.

If one banknote having a tape attached thereto is inserted between the rollers, the detection roller is raised, corresponding to the thickness of the one banknote, when a part of the banknote having no tape attached thereto is advanced between the rollers. When a part of this banknote having the tape attached thereto is advanced between the rollers, the detection roller will be further raised, by the thickness of the tape.

Using above mentioned mechanical configuration, each thickness data, as the output signal, will be obtained over the one sheet of each banknote. By utilizing the mechanical clock, with a predetermined pitch (e.g., for each 2 mm advancement of the banknote), each voltage value is subjected to the AD conversion and then stored in the memory, as a zone value Zi, over the one sheet of each banknote.

As the evaluation values, for example, a first evaluation formula, i.e., the total sum of the zone values ΣZi (i=1˜33) corresponding to the short-edge length of each banknote; a second evaluation formula, i.e., the total sum of the zone values, with the number of zones Zi exceeding 150; and a third evaluation formula, i.e., the total sum of the zone values, with the number of zones Zi exceeding 200; and the like can be mentioned.

When the banknotes of various countries are recognized, the length of each banknote should vary in accordance with the denomination of the banknote. Therefore, the number of the zones to be read by the recognition unit should also vary with the denomination of each banknote. Further, since the thickness of each banknote should vary in accordance with the denomination of the banknote, the threshold values for evaluating the thickness should also vary with the denomination of each banknote.

Because the dollar banknotes respectively have the same thickness over all of the denominations thereof, the thickness detection sensor 22 cannot be used for recognizing the denomination or authenticity of such banknotes. However, this thickness detection sensor 22 can detect a folded part of each banknote, two or more overlapped banknotes, each banknote having the tape attached thereto or the like between the upper and lower rollers. In this case, it is not necessary to provide the threshold value for each denomination. Namely, by determining if the banknotes are unfit or overlapped, such banknotes can be determined as unrecognizable banknotes.

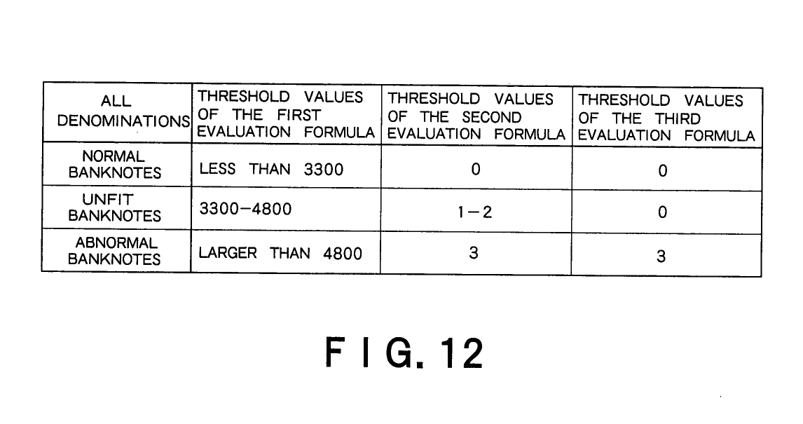

Further, if some banknotes are determined as the unrecognizable banknotes, such banknotes will be finally transported and stored in the reject unit 50. FIG. 12 shows one exemplary threshold-value table related to the recognition performed by the thickness detection sensor 22 about the fitness of each banknote.

In addition, the detection unit of the banknote recognition apparatus 220 is not limited to the red-light line sensor 21ac, infrared-light line sensor 21bc, magnetic sensor 24, optical sensor 26 and thickness detection sensor 22. For instance, the detection unit may include a mechanism for detecting the size of each banknote (in this case, the length in the short-edge direction and/or in the long-edge direction should vary with each denomination). In this case, the evaluation-value calculation unit 30 can calculate the evaluation value related to the size of each banknote, by using particular evaluation-value-calculation formulae.

1.-3. (canceled)

4. A banknote recognition apparatus for recognizing a denomination and an attribute of a banknote, the banknote recognition apparatus comprising:
a detection unit configured to detect the banknote to be recognized;
an evaluation-value calculation unit configured to calculate each evaluation value of the banknote, by using one evaluation-value-calculation-formula set composed of a combination of a plurality of predetermined evaluation-value calculation formulae, based on a detection result obtained by the detection unit; and
a recognition unit for recognizing the denomination of the banknote to be recognized, by using one set of predetermined threshold values for each denomination of banknote to be handled, respectively corresponding to the plurality of evaluation-value calculation formulae, as well as configured to recognize the attribute of the banknote to be recognized, by using another set of predetermined threshold values for each denomination of banknote to be handled, respectively corresponding to the plurality of evaluation-value calculation formulae, based on each evaluation value of the banknote calculated by the evaluation-value calculation unit;
wherein the recognition unit performs recognizing the denomination of the banknote and recognizing the attribute of the banknote, regardless of the recognized denomination of the banknote in parallel.

5. The banknote recognition apparatus according to claim 4, wherein the attribute of the banknote includes at least one of the authenticity of the banknote, fitness of the banknote and new or old printed version of the banknote.

6. The banknote recognition apparatus according to claim 4,
wherein the detection unit is configured to detect at least one of the thickness, size, optical transparency, optical reflectivity and magnetic data of the banknote, and
wherein the evaluation-value calculation unit is configured to calculate the evaluation value related to at least one of the thickness, size, optical transparency, optical reflectivity and magnetic data of the banknote.

7. The banknote recognition apparatus according to claim 4,
wherein the recognition unit evaluates the attribute of the banknote for each of the multiple denominations of banknote to be handled.

8.-10. (canceled)

11. A banknote recognition method for recognizing a denomination and an attribute of a banknote, the method comprising:
preparing one evaluation-value-calculation-formula set composed of a combination of a plurality of evaluation-value-calculation formulae, as well as preparing one set of threshold values for each denomination of banknote to be handled, respectively corresponding to the plurality of evaluation-value calculation formulae, and another set of threshold values for each attribute of banknote to be handled, respectively corresponding to the plurality of evaluation-value calculation formulae;
detecting the banknote to be recognized;
calculating each evaluation value of the banknote, by using the prepared one evaluation-value-calculation-formula set, based on a detection result of the banknote;
recognizing the denomination of the banknote to be recognized, by using the threshold values prepared for each denomination of banknote, respectively corresponding to the plurality of evaluation-value-calculation formulae, based on each evaluation value of the banknote; and
recognizing the attribute of the banknote to be recognized, by using the threshold values prepared for each denomination of banknote to be handled, respectively corresponding to the plurality of evaluation-value-calculation formulae, based on each evaluation value of the banknote;
wherein recognizing the denomination of the banknote and recognizing the attribute of the banknote are performed in parallel.

12. The banknote recognition method according to claim 11, wherein the attribute of the banknote includes at least one of the authenticity of the banknote, fitness of the banknote and new or old printed version of the banknote.

13. The banknote recognition method according to claim 11,
wherein at least one of the thickness, size, optical transparency, optical reflectivity and magnetic data of the banknote is detected during the detection of the banknote to be recognized, and
wherein the evaluation value related to at least one of the thickness, size, optical transparency, optical reflectivity and magnetic data of the banknote is calculated during the calculation of the evaluation value of the banknote.

14. The banknote recognition method according to claim 11,
wherein the attribute of the banknote is evaluated for each of the multiple denominations of banknote to be handled.

15. The banknote recognition apparatus according to claim 7,
wherein the final recognition on the denomination and attribute of the banknote is obtained by performing a logical AND operation of the recognized denomination and the recognized attribute for each denomination.

16. The banknote recognition method according to claim 14,
wherein the final recognition on the denomination and attribute of the banknote is obtained by performing a logical AND operation of the recognized denomination and the recognized attribute for each denomination.
